(19) United States
(12) Patent Application Publication
(10) Pub. No.: US 2004/0099010 A1
(43) Pub. Date: May 27, 2004

(54) Method and device for melting glass material

(76) Inventor: Sonny Johansson, Alsterbro (SE)

Correspondence Address: HARNESS, DICKEY & PIERCE, P.L.C., P.O. BOX 8910, RESTON, VA, 20195, US

(21) Appl. No.: 10/311,380

(22) PCT Filed: Jun. 15, 2001
(86) PCT No.: PCT/SE01/01354

(30) Foreign Application Priority Data
Jun. 16, 2000 (SE) 0002247-5

(51) Int. Cl. C03B 5/02; H05B 6/80

(52) U.S. Cl. 65/135.6; 204/157.43; 65/375

(57) ABSTRACT

A furnace is for melting of glass material, such as glass or glass batch, by use of microwaves. The furnace includes a container which is adapted to hold the glass material, and a device for emitting microwaves. The furnace includes a microwave absorber which is protected by a barrier from being decomposed by the glass material, the microwave absorber being adapted to absorb the energy of the microwaves and emit this energy as heat to the glass material.

### FIELD OF THE INVENTION

The present invention relates to a furnace for melting glass material, such as glass or glass batch, by means of microwaves, said furnace having a container which is adapted to hold the glass material, and means for emitting microwaves.

The invention also relates to a method of melting a glass material, such as glass or glass batch, by means of microwaves.

The invention further relates to a product of glass which has been made by means of the above device or method.

### BACKGROUND ART

Glass products are made of glass batch or molten glass. Glass batch or glass is melted in a crucible (batchwise process) or in a tank (continuous process). Traditionally the crucible or tank is heated from outside by means of gas or oil burners. This causes great heat losses on the one hand owing to the crucible or tank being heated from outside, which requires high temperatures to ensure that the central portion of the crucible or tank is sufficiently heated, and, on the other hand, owing to hot exhaust gases being discharged through a chimney. The fuel also causes a certain degree of contamination of the glass.

A more recent heating method is based on electric heating of the melt. In this case two electrodes of graphite or molybdenum are inserted into the melt and heat this by induction. This is disadvantageous on the one hand since glass does not conduct current at low temperatures, thus requiring the glass to be preheated, for instance by means of a gas burner, and on the other hand since the electrodes are gradually consumed, which contaminates the glass. The latter fact also applies to IR furnaces in which flakes from the IR tubes can fall into the melt.

WO97/26219 discloses a method and an apparatus for heating melt with a view to vitrifying nuclear waste. A melt, known as a “skull”, which is surrounded by unmelted material, which together with cooling devices protects a cavity from the melt, is heated by a single microwave source. An adjusting bolt is used to adjust the heat maximum of the microwave source in the centre of the cavity. The material must be preheated to be able to absorb microwave energy. In the method according to WO97/26219, this is carried out in two ways: either by means of a torch of argon plasma or by adding graphite as a material of consumption. Blocks of graphite are arranged in the centre of the fusible material. The microwaves are absorbed by the graphite blocks and heat them. Heat is emitted to the fusible material which melts and begins to absorb microwaves. The graphite blocks melt and accompany the fusible material out of the cavity. The method and the apparatus according to WO97/26219 comprise a plurality of complicated components and necessitate advanced controlling both when starting, holding the melt hot and withdrawing the product. The resulting product is very impure. The method and the apparatus according to WO97/26219 are intended for vitrifying of dangerous waste in cases where purity, cost and technical complexity are of minor importance. This method is thus inconvenient for production of utility glass and art glass and glass for technical applications.

### SUMMARY OF THE INVENTION

The object of the present invention therefore is to provide a furnace for melting of glass, which is simpler than the above devices and in which the melt will not be contaminated by residues of combustion, electrode material or graphite.

Another object of the present invention is to provide a method of melting glass, which method is more supple than the above methods, allows a melt to be produced which is not contaminated by residues of combustion, electrode material or graphite, and in which method only a small amount of energy is consumed.

A further object of the present invention is to provide a product of glass, which comprises high purity glass.

According to the invention, these objects are achieved by a furnace of the type mentioned by way of introduction and having the features that are evident from claim 1. Preferred embodiments of the furnace are evident from the subordinated claims 2-11.

The objects are also achieved by a method according to claim 12. Preferred embodiments of the method are evident from appended claims 13-17.

The objects are also achieved by a product according to claim 18.

The present invention relates to a furnace according to the preamble. This furnace is characterised in that it has a microwave absorber, which is protected by a barrier from being decomposed by the glass material, the microwave absorber being adapted to absorb the energy of the microwaves and to emit this energy as heat to the glass material. Microwaves are a pure form of energy that does not contaminate the glass material. The construction of the furnace will be simple since both handling of combustible fuels, gases and high current intensities are avoided and since only a single form of energy is used. The loss of energy is small since no exhaust gases or the like are generated. Since the glass material at room temperature does not absorb microwaves, it must be preheated. Preheating takes place by means of a microwave absorber which absorbs the energy of the microwaves and transfers it as heat to the glass material. A barrier protects the microwave absorber from the glass material. This is crucial since the microwave absorber would otherwise be dissolved in the glass material and contaminate the glass.

According to a preferred embodiment, the furnace container, which is made of a material that is permeable to microwaves, has a portion which contains the glass material, the microwaves on their way towards the microwave absorber at least partly passing through part of said portion. This is advantageous since the same means for emitting microwaves are arranged first to preheat the glass material by means of the microwave absorber and then, when the glass has been heated to a temperature at which it absorbs microwaves, to directly heat the glass material. The heating by the microwave absorber will thus automatically decrease at the same rate as the preheating is no longer required. A great advantage is that the microwaves heat the actual glass material, not the container. This decreases the heat load on the container and also the 100s of energy since the highest temperature will not be measured on the outside of the container but inside.

According to another preferred embodiment, the means are at least two magnetrons which are adapted to generate the microwaves, waveguides being adapted to direct the power from at least two magnetrons at a focusing point. Magnetrons are standard components and therefore readily available at a low price. Waveguides guide the radiation in the desired direction, which saves energy and decreases unwanted heating of objects and personnel in the vicinity of the furnace. The focusing point makes it possible to obtain maximum heating where it is most convenient.

The container has a centre in the vertical direction, the focusing point preferably being located below this centre in the vertical direction. Melted glass material will be heated most at the focusing point. The hottest glass material rises upwards, whereby the melt is being mixed. Mixing is most important to provide a homogeneous melt and prevent the forming of layers.

The container has a centre in the horizontal direction, the focusing point preferably being located at this centre in the horizontal direction. The hot melt in the centre will rise upwards while colder melt will fall along the walls of the container. This causes very favourable mixing and also saves energy since the glass melt at the walls of the container has a somewhat lower temperature than in the centre. Impurities will also be enriched at the walls of the container, which is advantageous since melted glass is often withdrawn from the surface at the centre of the container in the horizontal direction for further processing.

According to a preferred embodiment, the microwave radiation passes along a distance S through the glass material, the distance S being arranged so that the major part of the radiation is absorbable by the melted glass material. This is advantageous since, when the glass material has been heated so as to absorb microwave radiation, the microwave absorber will not absorb a very large amount of energy. This reduces the consumption of energy and reduces the heat load on microwave absorber, barrier and container, which increases their service life.

Preferably, at least one magnetron is arranged in such manner that its microwave radiation is directed downwards at an angle of 10-90°, more preferred 30-60°, to the horizontal plane. This has the advantage that the microwave radiation is not spread upwards out of the furnace, which could have a negative effect on the personnel in the vicinity of the furnace.

The microwave absorber is preferably made of a material which is adapted to have good absorption of microwaves and withstand high temperatures. Good absorption causes good energy efficiency since a large amount of the microwave energy is absorbed and can then be emitted as heat to the glass material. Since the microwave absorber withstands high temperatures, it will not be damaged, neither when absorbing microwaves and being heated nor when the glass material itself absorbs the radiation and emits a small amount of heat back to the microwave absorber. Therefore the microwave absorber can be used several times for heating. It is also important that no harmful gases or liquids be emitted during heating.

According to a still more preferred embodiment, the microwave absorber is made of silicon carbide. Silicon carbide, SiC, has very good absorption of microwaves, low thermal expansion, good resistance to thermal shocks, withstands high temperatures (above 1600° C.) and can be used several times for heating of the glass material.

According to a more preferred embodiment, the silicon carbide is particulate and has a particle size of 0.2-4 mm, preferably about 1 mm, to cause maximum heating of the container of about 1400-1500° C. Since the silicon carbide is particulate, its maximum heating will be limited. This causes the temperature increase to be automatically stopped, which decreases the risk of the container being damaged by excessive temperatures. The particle size is chosen in dependence on the desired maximum temperature in the container and the melt.

According to another preferred embodiment, the microwave absorber is made of aluminium oxide. Aluminium oxide has good absorption of microwaves and high temperature resistance.

The invention also relates to a method of melting glass according to the preamble. This method is characterised in that the energy of the microwaves is absorbed by a microwave absorber which is protected by a barrier from being decomposed by the glass material, the energy then being emitted as heat to the glass material which is held in a container. Microwaves constitute a pure form of energy that does not contaminate the glass material. The method of melting glass will be supple since both handling of combustible fuels, gases and high current intensities are avoided and since only one form of energy is used. The amount of energy lost is very small since no exhaust gases or the like are generated. Since the glass material at room temperature does not absorb microwaves, it must be preheated. The glass is preheated by means of a microwave absorber. The energy of the microwaves is absorbed by the microwave absorber and then emitted as heat to the glass material. The microwave absorber is protected from the glass material by means of a barrier. This is crucial since the microwave absorber would otherwise be dissolved in the glass material and contaminate the glass.

In the method, the glass material is suitably heated by the microwave absorber to at least a temperature at which the glass material begins to absorb microwave energy, after which the temperature of the glass material increases further by energy from microwaves, which on their way towards the microwave absorber pass through the glass material, being absorbed by the glass material. This has the advantage that the microwaves are absorbed by the microwave absorber which in turn preheats the glass material. When the glass has been heated to a temperature at which it absorbs microwaves, the microwaves are instead absorbed by the glass material, and the heating by the microwave absorber is automatically decreased at the same rate as the heating is no longer required. A great advantage is that the microwaves heat the actual glass material, not the container. This reduces the heat load on the container and also the loss of energy since the highest temperature will not be measured on the outside of the container, but inside.

The container has a centre in the vertical direction, the microwave radiation from at least two magnetrons preferably being directed at a focusing point which is located below said centre in the vertical direction, the high heat at the focusing point causing melted glass material to be mixed by the hotter glass material at the focusing point rising upwards. This has the advantage that the melt is being mixed, thereby preventing the forming of layers.

The container has a centre in the horizontal direction, the microwave radiation from at least two magnetrons preferably being directed at a focusing point which is located at the centre of the container in the horizontal direction, the high heat at the focusing point causing melted glass material to be mixed by the hotter glass material at the focusing point rising upwards and cooler glass material flowing downwards along the walls of the container. As a result, melted glass material is being mixed in a very favourable manner while at the same time energy is saved since the melt at the walls of the container has a somewhat lower temperature than in the centre. Pollutants, if any, will also be enriched at the walls of the container, which is advantageous since melted glass is often withdrawn from the surface at the centre of the container in the horizontal direction for further processing.

The temperature of the glass material is suitably set by switching on and off one or more of a plurality of magnetrons. A magnetron functions best when operating with a specific power. Controlling of the total power supplied to glass material and microwave absorber, and thus the temperatures thereof, functions smoothly if a plurality of magnetrons are connected to a common temperature control that switches on the necessary number of magnetrons, which each operate with their specific power.

Advantageously the glass material is heated by the microwave absorber to a temperature of about 500-1000° C. and then, by absorption of microwave energy, to a temperature above the melting temperature, about 1200-1500° C., after which the supplied microwave energy is set so that the temperature of the glass material falls to about 950-1100° C., after which the glass material is withdrawn from the container for further processing. This method results in excellent melted glass which, for instance, can be free-blown or processed in some other manner.

The invention also relates to a product of glass according to the preamble. This product is characterised in that it is high purity glass and has been made by means of the above method or device. The method and the device are smooth and simple and have a low consumption of energy, which means that the glass produced will have a low price. Owing to the very low degree of contamination, which is due to the heating with microwaves as well as the microwave absorber and its barrier, the glass will be high purity glass, which is advantageous both in the production of utility and art glass, such as drinking glasses, bowls, plates, glass sculptures, and in the production of glass for technical applications, such as lenses, mirrors, prisms, cuvettes, windows and optical fibres.

### BRIEF DESCRIPTION OF THE DRAWINGS

The invention will be further described below by means of two embodiments and with reference to the accompanying drawings.

FIG. 1 is a sectional view and illustrates a furnace according to the invention seen from the side.

FIG. 2 is a top plan view of the furnace.

FIG. 3 is an enlargement of a detail and illustrates a magnetron.

FIG. 4 is an enlargement of a detail and illustrates schematically the ray paths of the microwaves in a container.

FIG. 5 is a schematic sectional view and illustrates a tank seen from above.

FIG. 6 is a sectional view along line VI-VI in FIG. 5 and illustrates a tank according to the invention seen from the side.

### DESCRIPTION OF PREFERRED EMBODIMENTS

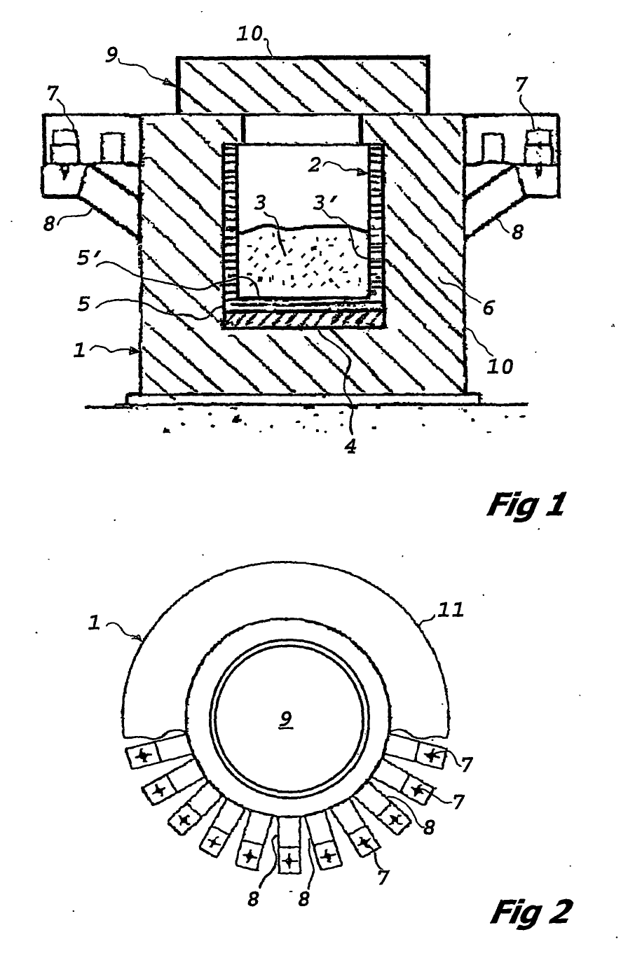

FIG. 1 shows a furnace 1 which has a container 2, also referred to as crucible, for glass material 3. The container 2 is made of a standard type silicate material as used in the glass industry, which is permeable to microwaves. The glass material 3 which is contained in a portion 3′ of the container 2 can be, for example, glass batch or crushed glass. Under the container 2, a microwave absorber 4 is arranged, which comprises silicon carbide particles having a particle size of about 1 mm. A barrier 5 protects the microwave absorber 4 from being dissolved by the glass material 3. The barrier 5 is the bottom 5′ of the container 2. The container 2 and the microwave absorber 4 are insulated by a thick layer of insulation 6, which is of a type that withstands high temperature and absorbs only a small amount of energy or no energy at all from microwaves. The microwaves are emitted by magnetrons 7 and passed through waveguides 8 towards the microwave absorber 4. An insulated cover 9 is positioned on top of the furnace 1. The cover 9 can be removed, thereby allowing glass material 3 to be supplied. When the cover 9 or a part thereof is removed, melt can be withdrawn, for example using a blow pipe, for further processing, for instance by free-blowing. The insulation 6 and the cover 9 are on the outside of the furnace 1 provided with metal coatings 10. The metal coatings 10 prevent microwaves from reaching the surroundings of the furnace 1.

Twenty-four magnetrons 7 are arranged round the container 2. A cooling jacket 11, which in FIG. 2 has been partially removed, encapsulates the magnetrons 7 and conducts cooling air from a fan (not shown) to the magnetrons 7.

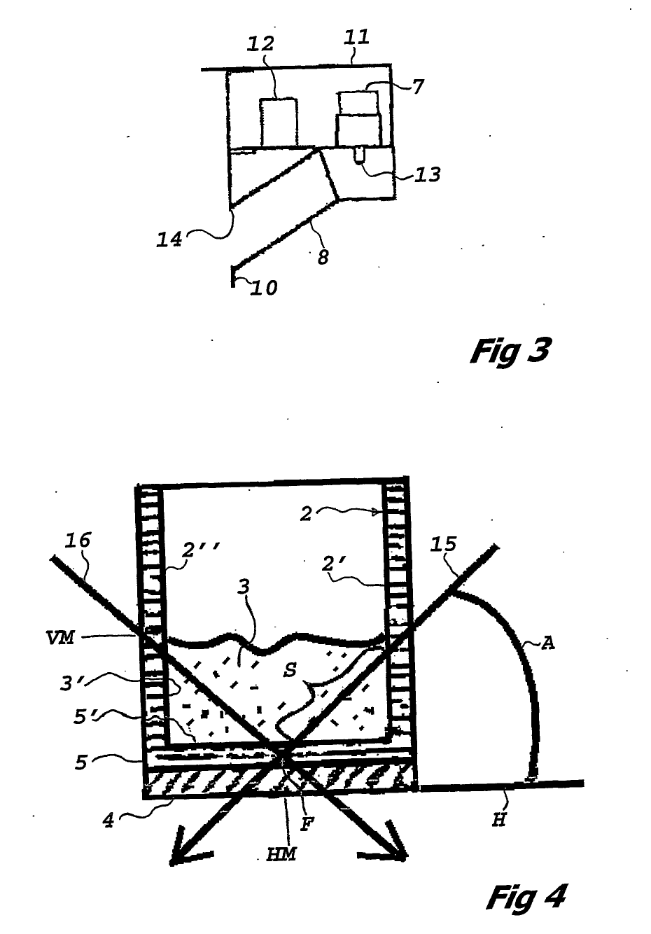

FIG. 3 illustrates a transformer 12 which supplies current at high voltage to the magnetron 7. Also the transformer 12 is cooled by cooling air in the cooling jacket 11. The magnetron 7 has an antenna 13 which emits microwaves. A waveguide 8 guides the microwaves in the desired direction, i.e. towards the microwave absorber 4. The waveguide 8 is hollow and made of sheet metal so that microwave radiation will not be emitted to the surroundings but conducted in the desired direction. The casing 10 has in the lower part of the wave guide 8 an opening 14 which is of essentially the same cross-section as the waveguide 8, through which opening 14 the microwaves are conducted towards the microwave absorber 4.

FIG. 4 is a schematic view of two microwave rays 15, 16 which are emitted by two opposite magnetrons 7. The angle A of the ray 15, 16 to a horizontal plane H is 45°. The rays 15, 16 pass through the insulation 6 and the walls 2′, 2″ of the container 2, continue through the glass material 3, pass through the barrier 5 which consists of the bottom 5′ of the container 2, and reach the microwave absorber 4. The ray 15, 16 passes through the glass material 3 along a distance S. The distance S is arranged so that, when the glass material 3 has reached full absorption of microwaves, the major part of the microwave radiation is absorbed by the glass material 3 and no microwave radiation at all, or only a small part thereof, reaches the microwave absorber 4.

A plurality of rays 15, 16 from a plurality of magnetrons 7 intersect at a common focusing point F. The focusing point F is located below the centre VM of the container 2 in the vertical direction. The focusing point F is located at the centre HM of the container 2 in the horizontal direction.

When glass material 3 is to be melted, a container 2 in the form of a crucible, which from the start is empty, must first be heated. The container 2 requires a slow increase in temperature, about 10-20° C./h, so as not to crack. A control system (not shown) measures the temperature in the container 2 and switches on a suitable number of magnetrons 7. The energy of the microwaves is absorbed by a microwave absorber 4 and is then emitted as heat, which radiates through a barrier 5, which protects the microwave absorber 4 from being decomposed by the glass material 3, and heats the container 2.

When the temperature of the container 2 has risen to about 1100° C., glass material is supplied to fill about half the volume of the container 2, thereby preventing overboiling. The glass material is heated by the hot container 2 to about 800° C., and then the glass material 3 begins to absorb the energy from the microwaves. As the glass material 3 starts to absorb an increasing extent of the radiation, the temperature of the microwave absorber 4 falls and the glass material 3 will be the hottest component in the furnace. The very hottest glass material will be found at the focusing point F. The temperature at this point can be about 150° C. higher than along the walls 2′, 2″ of the container 2. The glass material 3 is heated to the desired temperature by the temperature control switching on a suitable number of magnetrons 7. The glass material 3 is melted at about 1200-1400° C. Additional glass material 3 is supplied gradually at a rate that prevents temperature shocks in the container 2. Melted glass material 3 at the focusing point F rises upwards, and cooler glass material 3 falls downwards along the walls 2′, 2″ of the container 2. As a result, the melted glass material 3 is mixed while at the same time pollutants, if any, are enriched along the walls 2′, 2″ of the container. Further heating to 1400-1500° C., i.e. refining or plaining, can be carried out for the purpose of freeing the melted material of bubbles. The melted glass is then allowed to cool somewhat to working temperature, about 950-1100° C. When glass material 3 is to be withdrawn from the container 2, the magnetrons 7 are optionally switched off for a short period, to prevent microwaves from spreading out of the furnace 1, the cover 9 is opened and glass material 3 is withdrawn from the container 2 by means of e.g. a blow pipe. The products of glass (not shown) which are produced have all the requirements to have a very high degree of purity since the glass material 3 has not been affected by impurities from fuel, electrodes or microwave absorber.

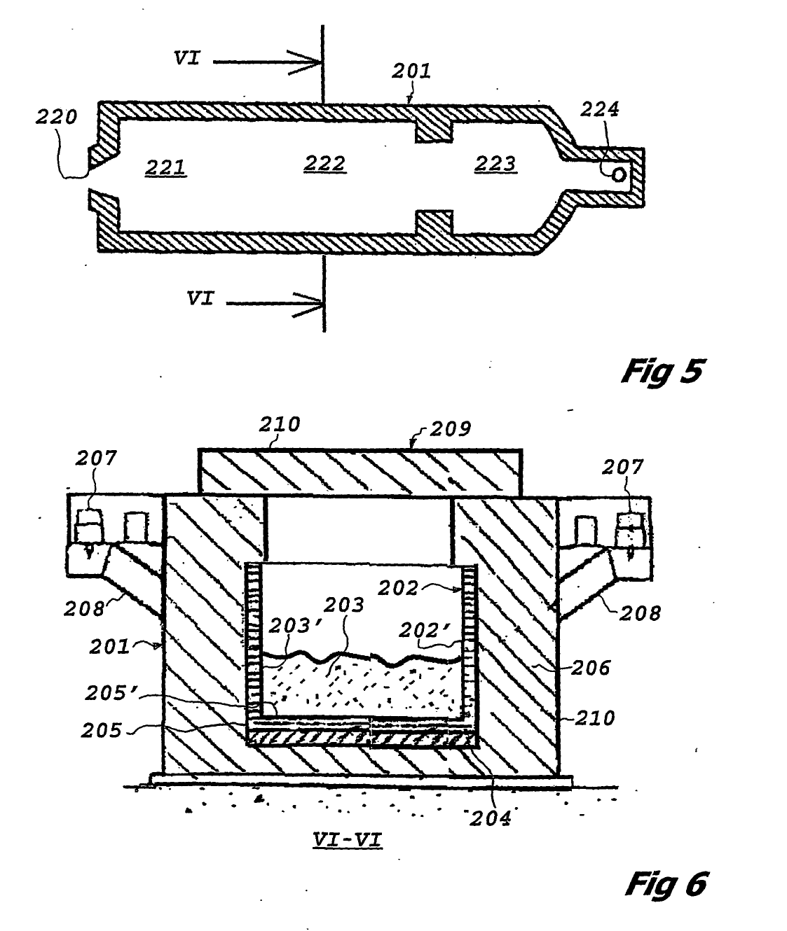

According to another preferred embodiment, the microwaves are used to heat a furnace of a type referred to as a tank 201, as shown in FIG. 5. Tanks 201 are used for continuous melting of glass material 203, in which glass material 203 is continuously supplied to one end of the tank 201 and the melt is withdrawn from the other end. The glass material 203 is thus supplied through an inlet 220. The glass material 203 melts in a melting zone 221 and is then refined in a plaining zone 222. The glass material 203 flows on to a working tank 223, from which it is withdrawn through an outlet 224 for further processing. The tank 201 has an elongate container 202, is illustrated in FIG. 6, which is made in a manner known to those skilled in the art and which contains the glass material 203 in a portion 203′. The microwave absorber 204 is arranged under the container 202 and protected from the glass material 203 by the barrier 205 that consists of the bottom 205′ of the container 202. The container 202 and the microwave absorber 204 are insulated by a thick layer of insulation 206 which is of a type that withstands high temperatures and absorbs only a small amount of energy, or no energy at all, from microwaves. The microwaves are emitted by magnetrons 207 which are arranged along the container 202 and are conducted by means of waveguides 208 through the walls 202′ of the container 202, the glass material 203 and the barrier 205 towards the microwave absorber 204. An insulated cover 209 is arranged on top of the tank 201. The container 202, the microwave absorber 204, the insulation 206 and the cover 209 are enclosed by metal casings 210. The metal casings 210 prevent microwaves from reaching the surroundings of the tank 201. The temperature in the various zones 221, 222, 223 is controlled by a number of magnetrons 207 being switched on or off. The magnetrons 207 are divided into groups, one group for each zone, so that an individual temperature can be set in each zone 221, 222, 223.

It will be appreciated that a large number of modifications of the above-described embodiments of the invention are feasible within the scope of the invention, as defined by the appended claims.

Thus, the container 2, 202 can be made in many different shapes, such as cylinder, sphere, right parallelepiped, and from a plurality of materials. In particular it has been found that the method and the device according to the invention cause significantly less load on containers in the form of crucibles. Crucibles, which is of a type that is often used in art glassworks, have been found to withstand quicker heating, 25-30° C./h, and above all more heatings from a cold state when they have been used in a furnace according to the invention. Traditional glasswork crucibles do not withstand such quick heating and are time-consuming to manufacture, since long conditioning times are necessary, but are also very useful in furnaces according to the invention. These, too, are exposed to significantly lower heat load in the method according to the invention compared with prior-art methods.

The microwave absorber 4 can be made of many different materials, which withstand high temperatures and which have good absorption of microwaves. Generally, solid and liquid materials having dipolar molecule or crystal structure, for instance silicon carbide and many oxides, satisfy the latter requirement. Materials, such as silicon carbide, which contain carbon in combination with a stabilising material, such as silicon, have in many cases good absorption and high temperature resistance. An example of a usable oxide is aluminium oxide which contains Al₂O₃ and has good temperature resistance and good absorption of microwaves. The microwave absorber can be in the form of a block, particles or even liquid. In the two latter cases, some kind of box is used to hold the microwave absorber in place.

The microwave absorber 4, 204 can, besides being arranged under the container 2, 202, also be arranged at the side of the container or on top thereof. The microwave absorber can also be divided into a plurality of parts arranged in different positions.

The microwave absorber 4, 204 can also be heated by one or more separated magnetrons, which heat the microwave absorber only, not the glass material. The actual glass material can then be heated by another group of magnetrons or by means of some other method, e.g. induction. In the latter case, the furnace according to the invention will serve as practical preheating before the induction process, which also requires hot glass material in order to function. The barrier 5, 205, which protects the microwave absorber 4, 204 from being dissolved by the glass material, can be designed in different ways. Preferably, the barrier is part of the container, which must in any case be made of a material, such as different silicate and clay materials, that withstands the influence of the glass material. Thus, the barrier may comprise the bottom, walls or, less preferred, cover of the container. It is also possible to integrate the microwave absorber into a barrier, which is made, for instance, of a silicate or clay material, and then wholly or partly lower this packet in the container. The barrier can also be a separate part that does not constitute part of the container.

The microwave absorber 4, 204 must be placed so close to the container 2, 202 and the glass material 3, 203 that the emitted heat to a large extent really reaches the container and the glass material. The arrangement of the microwave absorber under the bottom of the container is therefore preferable.

The insulation 6, 206 is suitably made of a material that withstands high temperatures and does not contain large amounts of aluminium. Insulating materials containing a large amount of aluminium frequently absorb quite a large amount of the microwave energy, which is undesirable. An example of a usable insulating material is Carbolane from Saint-Gobain.

The size and number of the magnetrons 7, 207 are adjusted to the amount of glass material to be heated. It has been found particularly advantageous to use magnetrons of standard size, for instance those having a power of about 700 W, which are used in microwave ovens. These are easily available and the cost price is low. The fact that a fairly large amount of magnetrons must be used has the advantage that controlling the temperature by switching on and off magnetrons results in excellent accuracy in the setting of temperature. It is also possible to exchange damaged magnetrons during operation.

The dimensions of the waveguide 8 are conveniently adjusted to the wavelength that is generated by the magnetron 7. In the case at issue, the cross-section of the waveguide 8 is suitably about 90 mm in width and 30 mm in height. Great variations of these dimensions are, however, possible without significantly reducing the power.

The cover 9 can be designed in many different ways and it can also be formed with an opening. The size and direction of the opening, opening device etc. can be adjusted to the location, size and field of application of the furnace so that glass material can easily be withdrawn from the furnace.

The cooling air duct 11 removes some excess heat from magnetrons and transformers. The thus heated air is essentially clean and can be used for heating purposes.

The coating 10, 210 can be either relatively thick and then have both radiation-protecting and supporting functions, or consist of thin metal sheet or a grating and then only screen microwave radiation from the ambient air.

The rays 15,16 from the magnetrons 7, 207 can be directed at different angles. Preferably the rays are directed away from that part of the container where glass material is withdrawn for further processing. In containers where the glass material is removed at the upper end, the rays are directed downwards at an angle of 10-90°, more preferred 30-60°.

The focusing point F is preferably positioned in the lower portion of the container. The focusing point can also be located under the bottom of the container.

The method of heating the glass material 3, 203 can be varied in many different ways. In the method as described above, the container is first heated to a high temperature by the microwave absorber, and then the glass material is supplied, which is heated by the hot container (and the microwave absorber). Alternatively, the heating of the container 2, 202 is begun with glass material 3, 203 in the container from the start. In this case, the glass material is heated more directly by the microwave absorber.

1. A furnace for melting of glass material (3; 203), such as glass or glass batch, by means of microwaves, said furnace (1; 201) having a container (2; 202) which is adapted to hold the glass material (3; 203), and means (7; 207) for emitting microwaves, characterised in that it has a microwave absorber (4; 204), which is protected by a barrier (5; 205) from being decomposed by the glass material (3; 203), the microwave absorber (4; 204) being adapted to absorb the energy of the microwaves and to emit this energy as heat to the glass material (3; 203).

2. A furnace as claimed in claim 1, in which the container (2; 202) which is made of a material permeable to microwaves, has a portion (3′; 203′) containing the glass material (3; 203), the microwaves on their way towards the microwave absorber (4; 204) at least partly passing through part of said portion (3′; 203′).

3. A furnace as claimed in claim 1 or 2, in which the means (7; 207) are at least two magnetrons (7; 207) which are adapted to generate the microwaves, waveguides (8; 208) being adapted to direct the power from at least two magnetrons (7; 207) at a focusing point (F).

4. A furnace as claimed in claim 3, in which the container (2; 202) has a centre (VM) in the vertical direction, the focusing point (F) being located below this centre (VM) in the vertical direction.

5. A furnace as claimed in claim 3 or 4, in which the container (2; 202) has a centre (HM) in the horizontal direction, the focusing point (F) being located at this centre (HM) in the horizontal direction.

6. A furnace as claimed in claim 2, in which the microwave radiation passes along a distance (S) through the glass material (3; 203), the distance (S) being arranged so that the major part of the radiation is absorbable by the melted glass material (3; 203).

7. A furnace as claimed in any one of the preceding claims, in which at least one magnetron (7; 207) is arranged in such manner that its microwave radiation is directed downwards at an angle (A) of 10-90°, more preferred 30-60°, to the horizontal plane (H).

8. A furnace as claimed in any one of the preceding claims, in which the microwave absorber (4; 204) is made of a material which is adapted to have good absorption of microwaves and withstand high temperatures.

9. A furnace as claimed in claim 8, in which the microwave absorber (4; 204) is made of silicon carbide.

10. A furnace as claimed in claim 9, in which the silicon carbide is particulate and has a particle size of 0.2-4 mm, preferably about 1 mm, to cause maximum heating of the container (2; 202) of about 1400-1500° C.

11. A furnace as claimed in claim 8, in which the microwave absorber (4; 204) is made of aluminium oxide.

12. A method of melting a glass material (3; 203), such as glass or glass batch, by means of microwaves, characterised in that the energy of the microwaves is absorbed by a microwave absorber (4; 204) which is protected by a barrier (5; 205) from being decomposed by the glass material (2; 203), the energy then being emitted as heat to the glass material (3; 203) which is held in a container (2; 202).

13. A method as claimed in claim 12, in which the glass material (3; 203) is heated by the microwave absorber (4; 204) to at least a temperature at which the glass material (3; 203) begins to absorb microwave energy, after which the temperature of the glass material (3; 203) increases further by energy from microwaves, which on their way towards the microwave absorber (4; 204) pass through the glass material (3; 203), being absorbed by the glass material (3; 203).

14. A method as claimed in claim 12-13, in which the container (2; 202) has a centre (VM) in the vertical direction, the microwave radiation from at least two magnetrons (7; 207) being directed at a focusing point (F) which is located below said centre (VM) in the vertical direction, the high heat at the focusing point (F) causing melted glass material (3; 203) to be mixed by the hotter glass material (3; 203) at the focusing point (F) rising upwards.

15. A method as claimed in any one of claims 12-14, in which the container (2; 202) has a centre (HM) in the horizontal direction, the microwave radiation from at least two magnetrons (7; 207) being directed at a focusing point (F) which is located at the centre (HM) of the container in the horizontal direction, the high heat at the focusing point (F) causing melted glass material (3; 203) to be mixed by the hotter glass material (3; 203) at the focusing point (F) rising upwards and the cooler glass material (3; 203) flowing downwards along the walls (2′, 2″; 202′) of the container (2; 202).

16. A method as claimed in any one of claims 12-15, in which the temperature of the glass material (3; 203) is set by one or more of a plurality of magnetrons (7; 207) being switched on and off.

17. A method as claimed in any one of claims 12-16, in which the glass material (3; 203) is heated by the microwave absorber (4; 204) to a temperature of about 500-1000° C., and then, by absorption of microwave energy, heated to a temperature above the melting temperature, about 1200-1500° C., after which the supplied microwave energy is set so that the temperature of the glass material falls to about 950-1100° C., after which glass material (3; 203) is withdrawn from the container (2; 202) for further processing.

18. A product of glass, characterised in that it is high purity glass and has been made by means of the device or method according to any one of the preceding claims.
